(19) United States
(12) Patent Application Publication
(10) Pub. No.: US 2012/0329955 A1
(43) Pub. Date: Dec. 27, 2012

(54) POLYSILOXANE BLOCK COPOLYMERS AND THE USE THEREOF IN COSMETIC FORMULATIONS

(75) Inventors: Dirk Kuppert, Aschaffenburg (DE); Burghard Gruening, Essen (DE); Yun Yang, Midlothian, VA (US)

(73) Assignee: EVONIK GOLDSCHMIDT GMBH, Essen (DE)

(21) Appl. No.: 13/583,395

(22) PCT Filed: Apr. 19, 2011
(86) PCT No.: PCT/EP2011/056206

§ 371 Date: Sep. 7, 2012

Related U.S. Application Data
(60) Provisional application No. 61/346,087, filed on May 19, 2010.

(51) Int. Cl. C08F 293/00

(52) U.S. Cl. 525/340

(57) ABSTRACT

The present invention relates to specific polyorganosiloxane block copolymers obtainable by radical polymerization, and to the use of the polyorganosiloxane block copolymers for the preparation of cosmetic or pharmaceutical compositions or body care compositions.

The invention relates to polyorganosiloxane compounds (polysiloxane block copolymers), in particular those which are suitable for use in cosmetic formulations and formulations for body care. The invention further relates to the preparation of the polyorganosiloxane compounds by nitroxide-based controlled radical polymerization (abbreviated hereinbelow to NMP (“nitroxide mediated polymerization”) for short), and to compositions comprising the polyorganosiloxane compounds, and to their use in cosmetic and body care applications.

Cosmetic and pharmaceutical compositions, and body care compositions, such as, for example, hair styling sprays, hair conditioners, foams, gels and shampoos often comprise resins, gum and polymers with an adhesive effect in order to generate a large number of advantageous effects, such as e.g. film-forming properties, thickening properties, sensory properties, such as improved feel and hair-shaping properties.

Polymers which are used in such formulations are, inter alia, but not exclusively, organic or silicone-containing linear or grafted copolymers which can be composed of a large number of different monomers. In this connection, the polymer blocks may be alternating, random, blockwise-constructed, branched or hyperbranched or homopolymer blocks.

Grafted polymers are known as film-forming polymers in cosmetic formulations for the treatment of hair or skin. These grafted polymers typically comprise a polymeric backbone and one or more macromonomers grafted onto the backbone, as a result of which the physical and chemical properties, such as e.g. the glass transition temperature and the solubility in water, can be adjusted independently of one another for the polymeric backbone and the grafted macromonomers in order to establish the desired overall properties of the entire polymer.

The specifications WO 95/01383 and WO 95/01384 disclose the use of water- and alcohol-soluble or dispersible grafted copolymers in hair and skin care compositions in which the copolymer has a backbone and one or more polymer side chains, prepared by the random copolymerization of monomer A and monomer B. Monomer A is selected such that it has a hydrophobic character and macromonomer B has a long hydrophilic moiety. EP 0 412 704, EP 0 408 313 and EP 0 412 707 disclose the use of silicone-grafted acrylate copolymers in hair care applications. U.S. Pat. No. 4,988,506 describes the use of grafted polysiloxane copolymers in hair care applications.

WO 02/053111 describes the use of silicone polyether block copolymers with (AB)ₙ structures in aqueous, surface-active body cleaning compositions which have good cosmetic properties especially for the volume, the combability and the shine of hair.

Block copolymers have the advantage over grafted copolymers that the polymer structure can be better controlled. This is particularly decisive and important when the desire is to tailor polymers with regions which have specific physical and chemical properties, e.g. provide alternating “hard” and “soft” segments in a polymer for hair spray applications for improved hold and haptics.

U.S. Pat. No. 5,468,477 discloses cosmetic compositions comprising a vinyl-silicone grafted copolymer or a block copolymer characterized in that the copolymer comprises a silicone segment and a vinyl polymer segment. The block or grafted copolymer is prepared by free-radical polymerization of a mercapto-functionalized silicone, which functions as chain-transfer agent, with a vinylic monomer. Copolymers prepared by this method generally have low molecular weight and a low silicone content on account of the premature chain-termination reactions. Intramolecular crosslinking reactions additionally lead to an uncontrolled build-up of polymer. Consequently, polydisperse systems with a mixture of chain lengths and different molecular architectures are obtained.

An alternative approach for the synthesis of block copolymers is the use of organopolysiloxane macroinitiators. These are organopolysiloxanes which contain groups which can form free radicals. Such compounds are described in U.S. Pat. No. 5,523,365. The use for the preparation of copolymers is disclosed in WO 98/48771 and U.S. Pat. No. 6,074,628. A disadvantage of this process is the handling of hazardous organosiloxane macroinitiators that have a tendency toward explosive decomposition and which have to be used in significant amounts otherwise the end product contains too few silicone units. Furthermore, the large-scale preparation of the macroinitiators is extremely difficult and associated with considerable safety expenditure. Moreover, the reaction is inefficient since large amounts of unreacted silicone oil have to be separated off by means of a long-winded extraction. This process can be scaled up only with great difficulty.

WO 00/71606 describes a process for the preparation of polysiloxane block copolymers in which an organopolysiloxane macroinitiator is used in an atom transfer radical polymerization (ATRP) with copper salts as catalyst for the preparation of block copolymers with controlled architecture. Their use in cosmetic and body care compositions, in particular in formulations for the treatment of hair, is described. However, the specification discloses nothing about the copper content of the prepared polymers. Moreover, the prepared polymers are terminated with bromine atoms, which is disadvantageous for the use in cosmetic formulations.

WO 2009/043629 relates to polysiloxane block copolymers of the formula A[LB(S)Q]ₘ, where A is a polysiloxane block, L is a divalent organic linker, B is a polymer block composed of radically polymerizable monomers, S is a sulfur atom and Q is a monovalent organic radical and m is an integer from 1 to 50, to a process for their preparation, and to their use in cosmetics or body care. The process disclosed in WO 2009/043629 for the preparation of polysiloxane block copolymers is characterized in that it comprises the steps A) reaction of an atom transfer radical initiator, which is a polysiloxane macroinitiator of the formula A[LX]ₘ, which has at least one organically bonded halogen atom X, where A is a polysiloxane block, L is a divalent organic radical and m is an integer from 1 to 50, with radically polymerizable monomers in the presence of a catalyst having transition metal, such as e.g. copper, in a polymerization step and B) addition of a compound Q-SH where Q is a monovalent organic radical, to the polymerization mixture in step A). A disadvantage of this process is that halogen-containing initiators and copper are used and that these then have to be removed again in an additional process step.

Besides the ATRP, for the build-up of block copolymers it is also possible to use other controlled radical polymerization methods, such as e.g. the nitroxide controlled polymerization:

US 2008/0312377 discloses the preparation of a polydimethylsiloxane (PDMS) macroinitiator by the esterification of a PDMS terminated with only one OH group with iBA-DEPN, where iBA-DEPN has the following structure (formula I):

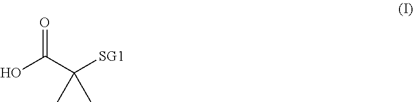

where SG1 is DEPN, where DEPN is the abbreviation for N-tert-butyl-N-[1-diethylphosphono(2,2-dimethylpropyl)]nitroxide having the following structure (formula II):

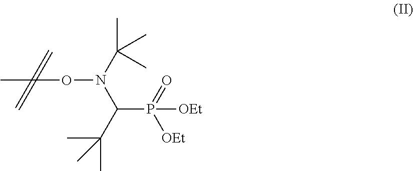

US 2008/0312377 likewise discloses the reaction of the macroinitiator with methyl methacrylate to give an A-B block copolymer. A disadvantage of this process is that very mild reaction conditions, which can only be generated industrially at high cost, have to be used for the esterification since iBA-DEPN decomposes even at temperatures >30° C. Furthermore, only simple monoalkoxyamine siloxanes are described, which are obtainable from monofunctionalized siloxanes. Such monofunctionalized siloxanes can only be prepared with very great difficulty and expenditure and furthermore very severely restrict the type of silicones that can be used. Moreover, US 2008/0312377 does not disclose an application of the described polymers in cosmetic formulations.

EP 1 464 648 discloses the preparation of alkoxyamines of the following general formula (III):

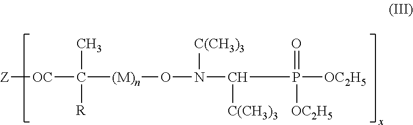

where R═H or CH₃ and M is a sequence of radically polymerizable vinylic monomers, n is an integer which may also be zero, X is greater than or equal to 1 and Z is a mono- or polyfunctional structural unit which may also be a silicone. However, EP 1 464 648 discloses nothing about the type of silicone, nor is an example listed.

The preparation of alkoxyamines of the above formula (III) takes place here by the linkage of alkoxyamines of the following formula (IV):

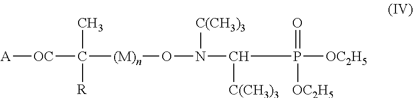

where A is an OH radical or TO radical, where T can be alkali metal such as Li, Na, K, NH₄ or a chlorine atom, where R═H or CH₃ and M is a sequence of radically polymerizable vinylic monomers, n is an integer which may also be zero, with a mono- or polyfunctional structural unit Z to form an ester functionality.

EP 1 526 138 B1 discloses the preparation of polyalkoxyamines with the formula (V)

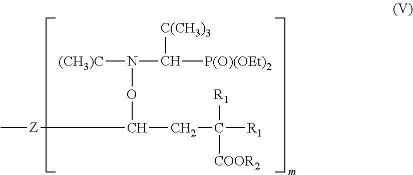

in which m is an integer less than or equal to n and greater than or equal to 2, in which, preferably under a nitrogen atmosphere, at least one monoalkoxyamine of the formula (VI)

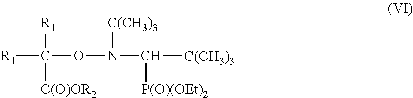

in which R¹ is a linear or branched alkyl radical having 1 to 3 carbon atoms, R² is a hydrogen atom, a linear or branched alkyl radical having 1 to 8 carbon atoms, a phenyl radical, an alkali metal such as Li, Na or K or an ammonium such as NH₄⁺, NBu₄⁺ or NHBu₃⁺ and preferably R¹ is CH₃ and R² is H; is reacted, optionally in the presence of one or more solvents, at a reaction temperature of preferably between 0 and 90° C., with a polyunsaturated compound of the formula (VII)

ZCH═CH₂]ₙ (VII)

in which Z is an aryl group or defined by formula Z1-[X—C(O)]ₙ, in which Z1 is a polyfunctional structure which is derived, for example, from a compound of the polyol type, X is an oxygen atom, a nitrogen atom with a carbon-containing group or else a hydrogen atom, where X may also be a sulfur atom and n is a number greater than or equal to two. EP 1 526 138 B1 makes neither a statement about whether Z or Z1 may also be a siloxane-containing polyfunctional structure, nor about the use of the described polymers in cosmetic formulations.

US 2006/0142511 describes the use of alkoxyamines of the formula (VI) for the polymerization and copolymerization of any desired monomers with a carbon-carbon double bond which can be radically polymerized. For the case R¹═CH₃ and R²═H in formula (VI), such an alkoxyamine is available under the trade name BlocBuilder® MA from Arkema. The polymerization is carried out under customary conditions known to the person skilled in the art. However, US 2006/0142511 discloses nothing about the use of polysiloxane-containing compounds in combination with alkoxyamines of the formula (VI).

It was therefore an object of the present invention to provide a process for the preparation of polyorganosiloxane compounds, in particular polysiloxane block copolymers which do not have one or more disadvantages of the prior art.

Surprisingly, it has been found that this object can be achieved by reacting radically polymerizable monomers in a nitroxide-based controlled radical polymerization with alkoxyamines of the formula (VI) to give a “living” polymer terminated with a nitroxide group and then covalently bonding these polymers onto an at least vinylically monounsaturated polysiloxane in a radical addition.

The present invention therefore provides polyorganosiloxane compounds of the formula (VIII)

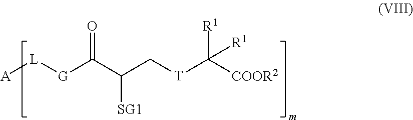

where
A is a polysiloxane block,
L is a divalent organic radical,
G=—O—, —S—, —CR³(OH)—CH(R³)—O—, —NR³—, where R³, independently of the others, is hydrogen or a monovalent substituted or unsubstituted, linear or branched radical containing 1 to 18 carbon atoms,
R¹ is identical or different and is a linear or branched alkyl radical having 1 to 3 carbon atoms, preferably CH₃,
R² is a hydrogen atom, a linear or branched alkyl radical having 1 to 8 carbon atoms, a phenyl radical, an alkali metal such as Li, Na or K or an ammonium such as NH₄⁺, NR⁵R⁶R⁷R⁸⁺ where R⁵, R⁶, R⁷ and R⁸, independently of one another, are H or C₁-C₄₀ alkyl radical, and preferably R² is H,
SG1 is a radical of the formula (II),

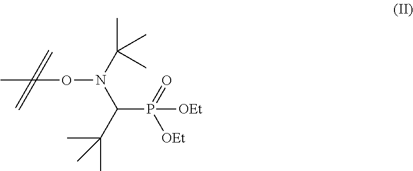

T is a block polymer composed of radically polymerized monomers, and
m is an integer from 1 to 50,
their use, and compositions which have these polyorganosiloxane compounds.

The present invention likewise provides a process for the preparation of polyorganosiloxane compounds according to the invention which is characterized in that it involves the steps:
A) reaction of at least one radically polymerizable monomer M with at least one alkoxyamine of the formula (VI)

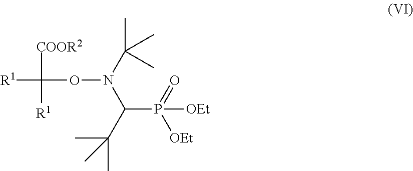

to give a nitroxide-terminated polymer (XV)

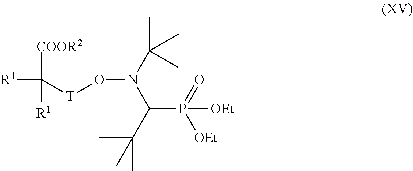

and
B) reaction of the polymer (XV) with an at least monounsaturated compound of the formula (XVI)

A[L-G-C(O)—CH═CH₂]m (XVI)
where R¹, R², A, L, G, T and m are as defined above.

The process according to the invention opened up an efficient and economical route to tailored siloxane-containing block copolymers. A disadvantage of the processes according to the prior art is that either the raw materials are not readily available or the siloxane moiety is variable only within restricted limits, which hinders broad usability of these block copolymers since the properties cannot be tailored. Moreover, for block copolymers constructed by means of ATRP, additional process steps are required for purification.

Using the process according to the invention, the siloxane moiety or the composition of the siloxane radical can be varied broadly. The compounds according to the invention can be used widely in the field of cosmetic and body care formulations, especially in hair care.

The polysiloxane block copolymers according to the invention, a process for their preparation and also their use are described below by way of example without intending to limit the invention to these exemplary embodiments. Where ranges, general formulae or compound classes are given below, these are intended to encompass not only the corresponding ranges or groups of compounds which are explicitly mentioned, but also all part ranges and part groups of compounds which can be obtained by removing individual values (ranges) or compounds. Where documents are cited within the context of the present description, then the intention is for their content, in their entirety, to form part of the disclosure of the present invention. Where data in percent are given below, these are percent by weight unless stated otherwise. Where average values are stated below, then these are number-averages unless stated otherwise.

The polyorganosiloxane compounds according to the invention of the formula (VIII)

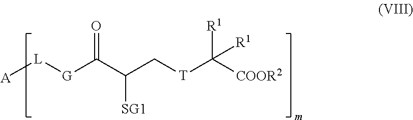

are characterized in that
A is a polysiloxane block,
L is a divalent organic radical,
G=—O—, —S—, —CR³(OH)—CH(R³)—O—, —NR³—, where R³, independently of the others, is hydrogen or a monovalent substituted or unsubstituted, linear or branched radical containing 1 to 18 carbon atoms,
R¹ is identical or different and is a linear or branched alkyl radical having 1 to 3 carbon atoms, preferably CH₃,
R² is a hydrogen atom or a linear or branched alkyl radical having 1 to 8 carbon atoms, a phenyl radical, an alkali metal cation such as Li⁺, Na⁺ or K⁺ or an ammonium such as NH₄⁺, NR⁵R⁶R⁷R⁸⁺ where R⁵, R⁶, R⁷ and R⁸, independently of one another, are H or C₁-C₄₀ alkyl radical, and preferably a hydrogen atom,
SG1 is a radical of the formula (II),

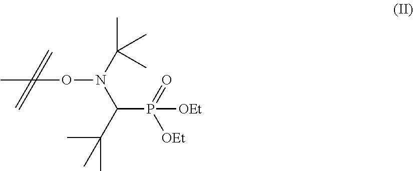

T is a polymer block composed of radically polymerized monomers, and
m is an integer from 1 to 50, preferably 2 to 10 and preferably 2, 3 or 4.

Preferred polyorganosiloxane compounds are those in which R¹=methyl and/or R²=hydrogen and/or G=oxygen. Particularly preferred polyorganosiloxane compounds are those in which R¹=methyl and R²=hydrogen and G=oxygen.

In the polyorganosiloxane compound according to the invention, the unit A is preferably a polysiloxane radical of the formula (IX)

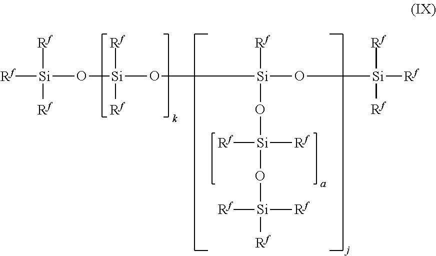

where
j is a number from 0 to 10, preferably <5 and particularly preferably 0,
k is a number from 1 to 500, preferably 1 to 250 and particularly preferably 1 to 100,
R^{f} is identical or different radicals R⁹ or a bond to the building block L with the proviso that m radicals R^{f} are a bond to the building block L,
R^{g} is substituted or unsubstituted alkyl radicals having 1 to 18 carbon atoms, preferably 1 to 6 carbon atoms, particularly preferably methyl or an aryl radical, preferably a phenyl radical.

It is known to the person skilled in the art that polysiloxane compounds are present, on account of their polymeric nature, in the form of a mixture with a distribution regulated essentially by the laws of statistics. The values for the indices j and k are therefore average values.

The radical L is preferably a radical —(O)ₓ-L′-, where L′ is bonded to G and is an unbranched or branched, substituted or unsubstituted organic radical having 1 to 60 carbon atoms, preferably 1 to 20 carbon atoms and particularly preferably 3-10 carbon atoms, and x=0 or 1. The radical L′ can be interrupted by divalent radicals which are bonded to carbon atoms on both sides, such as, for example, —O—, —C(O)O—, CONR^{p}, NR^{p}C(O), or —C(O)—, where R^{p} is a monovalent substituted or unsubstituted, linear or branched radical containing 1 to 18 carbon atoms. Particularly preferred polyorganosiloxane compounds are those in which L is a linear unbranched hydrocarbon radical having 3 to 10 carbon atoms, preferably a —CH₂—CH₂—CH₂— or —CH₂—(CH₂)₄—CH₂— radical.

The radically polymerizable monomers for constructing the block T can be selected from all known radically polymerizable monomers M. In the polyorganosiloxane compound according to the invention, the polymer block T is preferably composed of radically polymerized monomers M selected from substituted or unsubstituted (meth)acrylic acids and derivatives thereof and unsaturated hydrocarbons, in particular styrenes.

Preferably used monomers M include acrylic acid, methacrylic acid, ethacrylic acid, methyl acrylate, ethyl acrylate, n-butyl acrylate, isobutyl acrylate, t-butyl acrylate, 2-ethylhexyl acrylate, decyl acrylate, octyl acrylate, methyl methacrylate, ethyl methacrylate, n-butyl methacrylate, isobutyl methacrylate, t-butyl methacrylate, 2-ethylhexyl methacrylate, decyl methacrylate, octyl methacrylate, methyl ethacrylate, ethyl ethacrylate, n-butyl ethacrylate, isobutyl ethacrylate, t-butyl ethacrylate, 2-ethylhexyl ethacrylate, decyl ethacrylate, octyl ethacrylate, 2,3-dihydroxypropyl acrylate, 2,3-dihydroxypropyl methacrylate, 2-hydroxyethyl acrylate, 2-hydroxypropyl acrylate, 3-hydroxypropyl acrylate, 2-hydroxyethyl methacrylate, 3-hydroxypropyl methacrylate, glyceryl monoacrylate, glyceryl monomethacrylate, glyceryl monoethacrylate, glycidyl acrylate, glycidyl methacrylate, acrylamide, methacrylamide, ethacrylamide, N-methylacrylamide, N,N-dimethylacrylamide, N,N-dimethylmethacrylamide, N-ethylacrylamide, N-isopropyl-acrylamide, N-butylacrylamide, N-t-butylacrylamide, N,N-di-n-butylacrylamide, N,N-diethylacrylamide, N-octylacrylamide, N-octadecylacrylamide, N,N-diethylacrylamide, N-phenyl-acrylamide, N-methylmethacrylamide, N-ethylmethacrylamide, N-dodecylmethacrylamide, N,N-dimethylaminoethylacrylamide, quaternized N,N-dimethylaminoethylacrylamide, N-dimethyl-aminoethylmethacrylamide, quaternized N,N-dimethylamino-ethylmethacrylamide, N,N-dimethylaminoethyl acrylate, N,N-dimethylaminoethyl methacrylate, quaternized N,N-dimethyl-aminoethyl acrylate, quaternized N,N-dimethylaminoethyl methacrylate, 2-hydroxyethyl acrylate, 2-hydroxyethyl methacrylate, 2-hydroxyethyl ethacrylate, glyceryl acrylate, 2-methoxyethyl acrylate, 2-methoxyethyl methacrylate, 2-methoxyethyl ethacrylate, 2-ethoxyethyl acrylate, 2-ethoxyethyl methacrylate, 2-ethoxyethyl ethacrylate, maleic acid, the monoesters of maleic acid, the diesters of maleic acid, maleic anhydride, maleiimides, fumaric acid, itaconic acid, the monoesters of itaconic acid, the diesters of itaconic acid, itaconic anhydride, crotonic acid, angelic acid, diallyldimethylammonium chloride, vinylpyrrolidones, vinylimidazole, methyl vinyl ether, methyl vinyl ketone, vinylpyridine, vinyl furan, styrene sulfonate, allyl alcohol, allyl citrate, allyl tartrate, vinyl acetate, vinyl alcohol, vinylcaprolactam and mixtures thereof. Likewise suitable monomers M are hydrocarbons with at least one unsaturated carbon-carbon double bond, preferably selected from styrene, alpha-methylstyrene, t-butylstyrene, butadiene, isoprene, cyclohexadiene, ethylene, propylene, 1-butene, 2-butene, isobutene, para-methylstyrene and mixtures thereof.

In a very particularly preferred embodiment, the monomers M are mixtures of monomers which have from 50 to 99% by weight, preferably 75 to 95% by weight, of (meth)acrylic acid and derivatives thereof, in particular monomers selected from the group comprising methyl acrylate, methyl methacrylate, n-butyl acrylate, n-butyl methacrylate, N,N-dimethylaminoethyl acrylate, N,N-dimethylaminoethyl methacrylate, 2-hydroxyethyl methacrylate or monomers according to formulae (XIII), where the index o is preferably greater than 0, preferably from 10 to 15, and R^{r}═CH₃ and R^{s}=methyl, particularly preferably the indices o and p are greater than 0, and mixtures thereof, and from 1 to 50% by weight, preferably 5 to 25% by weight, of hydrocarbons having at least one unsaturated carbon-carbon double bond, preferably selected from styrene, alpha-methylstyrene, t-butylstyrene, butadiene, isoprene, cyclohexadiene, ethylene, propylene, 1-butene, 2-butene, isobutene, para-methylstyrene and mixtures thereof.

The unit T preferably has a number-average molecular weight of from 1000 g/mol to 200 000 g/mol, preferably a number-average molecular weight of from 4000 g/mol to 120 000 g/mol and particularly preferably from 4000 g/mol to 75 000 g/mol.

The building block T is particularly preferably a poly(meth)acrylate block, preferably with a number-average molecular weight of from 1000 g/mol to 200 000 g/mol, preferably with a number-average molecular weight of from 4000 g/mol to 120 000 g/mol and particularly preferably with a number-average molecular weight of from 4000 g/mol to 75 000 g/mol.

The polyorganosiloxane compounds according to the invention preferably have a number-average molecular weight of from 2000 g/mol to 1 000 000 g/mol, preferably from 5000 g/mol to 500 000 g/mol and very particularly preferably from 10 000 g/mol to 250 000 g/mol.

The polyorganosiloxane compounds according to the invention can be prepared in different ways. Preferably, the polyorganosiloxane compounds according to the invention are obtainable by the process according to the invention described below.

The process according to the invention for the preparation of the polysiloxane block copolymers according to the invention is characterized in that it involves the steps:
A) reaction of a radically polymerizable monomer M with at least one alkoxyamine of the formula (VI)

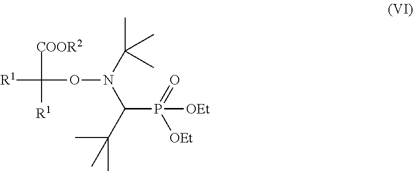

to give a nitroxide-terminated polymer (XV)

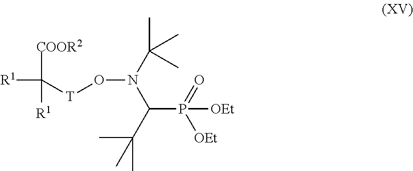

and
B) reaction of the polymer (XV) with an at least monounsaturated compound of the formula (XVI)

A[L-G-C(O)—CH═CH₂]ₘ (XVI)
where R¹, R², A, L, G, T and m are as defined above.

### Step A)

Process step A) involves the polymerization and/or copolymerization of at least one radically polymerizable monomer M with at least one alkoxyamine of the formula (VI), where R¹ is a linear or branched alkyl radical having 1 to 3 carbon atoms, R² is a hydrogen atom, a linear or branched alkyl radical having 1 to 8 carbon atoms, a phenyl radical, an alkali metal such as Li, Na or K or an ammonium such as NH₄⁺, NR⁵R⁶R⁷R⁸⁺ where R⁵, R⁶, R⁷ and R⁸, independently of one another, ═H or C1-C40 alkyl radical, and preferably R² is H, giving a nitroxide-terminated polymer of the formula (IX).

Very particularly preferably, an alkoxyamine according to formula (VI), where R¹═CH₃ and R²═H, is used. One such alkoxyamine is sold under the trade name BlocBuilder® MA by Arkema.

Radically polymerizable monomers H which are used in step A) are preferably ethylenically unsaturated monomers.

“Polymerizable” is understood as meaning monomers which, as described in the present invention, are polymerizable using the nitroxide-based controlled radical polymerization. Preferably, in the nitroxide-based controlled radical polymerization, the polymer chain length and the polymer architecture can be controlled in a known manner and it is possible to obtain polymers with a narrow distribution in terms of the polydispersity of the molar mass distribution (ratio of weight-average of the molar mass to the number-average of the molar mass).

“Ethylenically” unsaturated monomers are understood as meaning monomers which comprise at least one polymerizable carbon-carbon double bond, where the double bond may be mono-, di-, tri- or tetrasubstituted. It is possible to use either individual monomers or mixtures of monomers. The monomers are preferably selected such that they correspond to the desired physical and chemical properties of the polysiloxane block copolymer.

Preferred ethylenically unsaturated monomers M which can be used for the polymerization are those of the formula (XII)

H(R⁹)C═C(R¹⁰)(C(O)G′) (XII)

where radicals R⁹ and R¹⁰, independently of one another, can be selected from the group comprising hydrogen, unbranched or branched C₁- to C₁₀-alkyl radicals, methoxy, ethoxy, 2-hydroxyethoxy, 2-methoxyethyl and 2-ethoxyethyl radicals. The radical G can be selected from the group comprising -hydroxy, —O(M)_{1/v}, OR¹¹, —NH₂, —NHR¹¹ and —N(R¹¹)(R¹²); where M is a counterion of the valence v, selected from the group of the metal ions, such as alkali metal ions, alkaline earth metal ions, ammonium ions, substituted ammonium ions, such as mono-, di-, tri- or tetraalkylammonium ions, and each radical R¹¹ and R¹² can be selected independently from the group comprising hydrogen, C₁-C₄₀ straight-chain or branched alkyl chains, polyether radicals, polyetheramine radicals optionally substituted with one or more substituents selected from the group comprising hydroxy, amino, C₁-C₃ alkoxy, C₁-C₃ alkylamino and di(C₁-C₃ alkyl)amino, e.g. N,N-dimethylaminoethyl, 2-hydroxyethyl, 2-methoxyethyl, and 2-ethoxyethyl. Representative nonlimiting examples of monomers also include protected or unprotected acrylic acid and methacrylic acid, and also salts and esters and amides of these acids.

The salts can be derived from any desired metal, ammonium or substituted ammonium counterion. The esters can be derived from C₁-C₄₀ straight-chain, C₃-C₄₀ branched alkyl chains or C₃-C₄₀ carbocyclic alcohols, from polyfunctional alcohols comprising from 2 to 8 carbon atoms and from 2 to 8 hydroxy groups, from amino alcohols and polyethylene glycols or polypropylene glycols or other polyether radicals, and also hydroxy-group-functionalized polyethers, (nonlimiting examples include ethylene glycol, propylene glycol, butylene gylcol, hexylene glycol, glycerol and 1,2,6-hexanetriol), of amino alcohols (nonlimiting examples include aminoethanol, dimethylaminoethanol, diethylaminoethanol and quaternized products thereof) or of ether alcohols, such as e.g. methoxyethanol or ethoxyethanol.

The amides can be unsubstituted, N-alkyl- or N-alkylamino monosubstituted or N,N-dialkyl-, or N,N-dialkylamino-disubstituted, the alkyl or alkylamino groups being derived from C₁-C₄₀ straight-chain or C₃-C₄₀ branched, or C₃-C₄₀ cyclic units. Additionally, the alkylamino group can be quaternized.

Monomers that can likewise be used are protected or unprotected acrylic and/or methacrylic acids, salts, esters and amides thereof, where the second or third carbon position in the acrylic acids and/or methacrylic acids can be substituted independently of one another. The substituents can be selected from the group comprising C₁-C₄ alkyl radicals, hydroxyl, —CN, and —COOH, for example methacrylic acid, ethyacrylic acid and 3-cyanoacrylic acid. The salts, esters and amides of these substituted acrylic and methacrylic acids, as described above, can likewise be used.

Moreover, monomers M that can be used include: vinyl and allyl esters of straight-chain carboxylic acids containing 1 to 40 carbon atoms, branched carboxylic acids containing 3 to 40 carbon atoms or carbocyclic carboxylic acids containing 3 to 40 carbon atoms, pyridines substituted with at least one vinyl or allyl group (e.g. vinylpyridine or allylpyridine), hydrocarbons with at least one unsaturated carbon-carbon double bond (e.g. styrene, alpha-methylstyrene, t-butylstyrene, butadiene, isoprene, cyclohexadiene, ethylene, propylene, 1-butene, 2-butene, isobutene, para-methylstyrene) and mixtures thereof.

Preferably, the radically polymerizable monomers M used are substituted or unsubstituted (meth)acrylic acid or derivatives thereof. Preferably used monomers M include acrylic acid, methacrylic acid, ethacrylic acid, methyl acrylate, ethyl acrylate, n-butyl acrylate, isobutyl acrylate, t-butyl acrylate, 2-ethylhexyl acrylate, decyl acrylate, octyl acrylate, methyl methacrylate, ethyl methacrylate, n-butyl methacrylate, isobutyl methacrylate, t-butyl methacrylate, 2-ethylhexyl methacrylate, decyl methacrylate, octyl methacrylate, methyl ethacrylate, ethyl ethacrylate, n-butyl ethacrylate, isobutyl ethacrylate, t-butyl ethacrylate, 2-ethylhexyl ethacrylate, decyl ethacrylate, octyl ethacrylate, 2,3-dihydroxypropyl acrylate, 2,3-dihydroxypropyl methacrylate, 2-hydroxyethyl acrylate, 2-hydroxypropyl acrylate, 3-hydroxypropyl acrylate, 2-hydroxyethyl methacrylate, 3-hydroxypropyl methacrylate, glyceryl monoacrylate, glyceryl monomethacrylate, glyceryl monoethacrylate, gycidyl acrylate, glycidyl methacrylate, acrylamide, methacrylamide, ethacrylamide, N-methylacrylamide, N,N-dimethylacrylamide, N,N-dimethylmethacrylamide, N-ethylacrylamide, N-isopropyl-acrylamide, N-butylacrylamide, N-t-butylacrylamide, N,N-di-n-butylacrylamide, N,N-diethylacrylamide, N-octylarylamide, N-octadecylacrylamide, N,N-diethylacrylamide, N-phenyl-acrylamide, N-methylmethacrylamide, N-ethylmethacrylamide, N-dodecylmethacrylamide, N,N-dimethylaminoethylacrylamide, quaternized N,N-dimethylaminoethylacrylamide, N-dimethyl-aminoethylmethacrylamide, quaternized N,N-dimethylamino-ethylmethacrylamide, N,N-dimethylaminoethyl acrylate, N,N-dimethylaminoethyl methacrylate, quaternized N,N-dimethyl-aminoethyl acrylate, quaternized N,N-dimethylaminoethyl methacrylate, 2-hydroxyethyl acrylate, 2-hydroxyethyl methacrylate, 2-hydroxyethyl ethacrylate, glyceryl acrylate, 2-methoxyethyl acrylate, 2-methoxyethyl methacrylate, 2-methoxyethyl ethacrylate, 2-ethoxyethyl acrylate, 2-ethoxyethyl methacrylate, 2-ethoxyethyl ethacrylate, maleic acid, the monoesters of maleic acid, the diesters of maleic acid, maleic anhydride, maleiimides, fumaric acid, itaconic acid, the monoesters of itaconic acid, the diesters of itaconic acid, itaconic anhydride, crotonic acid, angelic acid, diallyldimethylammonium chloride, vinylpyrrolidones, vinylimidazole, methyl vinyl ether, methyl vinyl ketone, vinylpyridine, vinyl furan, styrene sulfonate, allyl alcohol, allyl citrate, allyl tartrate, vinyl acetate, vinyl alcohol, vinylcaprolactam, monomer according to formula (XIII)

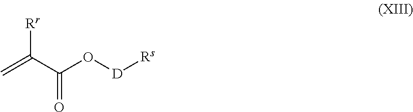

where D is a divalent radical of the general formula (XIV)

(C₂H₄O)ₒ(C₃H₆O)ₚ(C₄H₈O)_{q}(C₁₂H₂₄O)ᵣ(C₈H₈O)ₛ— (XIV)

where o, p, q, r and s, independently of one another, are integers from 0-100, with the proviso that the sum of o+p+q+r+s≧1, and if more than one of the indices o, p, q, r and s is >0, the general formula (XIV) is a random oligomer, a block oligomer or a gradient oligomer,
where R^{r}, independently of one another, are H or alkyl.

R^{s} is H, alkyl, preferably C₁- to C₃-alkyl, preferably methyl and mixtures of the monomers listed above.

Particular preference is given to monomers selected from the group comprising methyl acrylate, ethyl acrylate, n-butyl acrylate, isobutyl acrylate, t-butyl acrylate, 2-ethylhexyl acrylate, decyl acrylate, octyl acrylate, methyl methacrylate, ethyl methacrylate, n-butyl methacrylate, isobutyl methacrylate, t-butyl methacrylate, 2-ethylhexyl methacrylate, decyl methacrylate, octyl methacrylate, N-octylacrylamide, 2-methoxyethyl acrylate, 2-hydroxyethyl acrylate, N,N-dimethylaminoethyl acrylate, N,N-dimethylaminoethyl methacrylate, 2-hydroxyethyl methacrylate or monomers according to formulae (XIII), where the index o is preferably greater than 0, preferably from 10 to 15 and R^{r}=CH₃ and R^{s}=methyl, and mixtures thereof.

Very particular preference is given to using monomers selected from the group comprising methyl acrylate, methyl methacrylate, n-butyl acrylate, n-butyl methacrylate, N,N-dimethylaminoethyl acrylate, N,N-dimethylaminoethyl methacrylate, 2-hydroxyethyl methacrylate or monomers according to formulae (XIII), where the index o is preferably greater than 0, preferably from 10 to 15 and R^{r}=CH₃ and R^{s}=methyl particularly preferably, the indices o and p are greater than 0, and mixtures thereof.

In one very particularly preferred embodiment, mixtures of monomers are used which have from 50 to 99% by weight, preferably 75 to 95% by weight, of (meth)acrylic acid or derivatives thereof, in particular monomers selected from the group comprising methyl acrylate, methyl methacrylate, n-butyl acrylate, n-butyl methacrylate, N,N-dimethyl-aminoethyl acrylate, N,N-dimethylaminoethyl methacrylate, 2-hydroxyethyl methacrylate or monomers according to formulae (XIII), where the index o is preferably greater than 0, preferably from 10 to 15 and R^{r}=CH₃ and R^{s}=methyl particularly preferably, the indices o and p are greater than 0, and mixtures thereof, and from 1 to 50% by weight, preferably 5 to 25% by weight of hydrocarbons with at least one unsaturated carbon-carbon double bond, preferably selected from styrene, alpha-methylstyrene, t-butylstyrene, butadiene, isoprene, cyclohexadiene, ethylene, propylene, 1-butene, 2-butene, isobutene, para-methylstyrene and mixtures thereof.

The polymerization in step A) can take place without a diluent or in solution. The polymerization in step A) can be carried out as emulsion polymerization, miniemulsion or microemulsion polymerization or suspension polymerization.

If a solvent or solvent mixture is used in process step A), it is preferably selected from the group comprising water, alcohols, such as e.g. ethanol, n-propanol, isopropanol, n-butanol, 2-butanol, tert-butanol, pentanol, hexanol, heptanol, octanol, cyclohexanol, aromatic solvents, chlorinated and/or fluorinated solvents, ethers, such as e.g. tetrahydrofuran, 1,4-dioxane, organic esters, such as e.g. butyl acetate, ethyl acetate, propyl acetate; ketones, preferably ethyl methyl ketone, acetone; ethers; aliphatics, preferably pentane, hexane and further polar aprotic solvents. Here, the list is only exemplary and not exhaustive.

The amount of solvent or solvent mixture here is from 5 to 95% by weight, based on used amount of monomers M and alkoxyamine (VI), preferably from 10 to 75% by weight and very particularly preferably from 20 to 50% by weight.

If the reaction in step A) is carried out in a solvent or a solvent mixture, then the solvent can be removed prior to process step B) by distillation or by another method customary for the person skilled in the art.

The reaction according to step A) can be carried out at atmospheric pressure, subatmospheric pressure or superatmospheric pressure, preferably at atmospheric pressure.

The temperature in step A) of the process is preferably greater than or equal to 70° C. and particularly preferably greater than or equal to 80° C.

The reaction according to step A) is preferably carried out under a protective gas selected from the group comprising nitrogen, noble gases, CO₂ or gaseous hydrocarbons, such as e.g. methane, or mixtures thereof. Particular preference is given to the procedure under nitrogen as protective gas.

### Step B)

As monounsaturated compound of the formula A[L-G-C(O)—CH═CH₂]ₘ, it is possible to use all at least monounsaturated compounds which satisfy the formula A[L-G-C(O)—CH═CH₂]ₘ. At least monounsaturated compound of the formula A[L-G-C(O)—CH═CH₂]ₘ, can be obtained e.g. by firstly reacting a suitable vinylically unsaturated compound V with the reactive groups of a polysiloxane, e.g. in a nucleophilic substitution reaction.

In this reaction, the polysiloxane used is preferably a polysiloxane which has at least one functional group which has an O, N or S atom and is suitable for a nucleophilic attack on these atoms.

The polysiloxanes used for the preparation of at least monounsaturated polysiloxanes of the formula A[L-G-C(O)—CH═CH₂]ₘ can be linear, branched or hyperbranched, provided they are functionalized with at least one group as described above. Preference is given to using polysiloxanes which are selected from polysiloxanes of the formula (IXa),

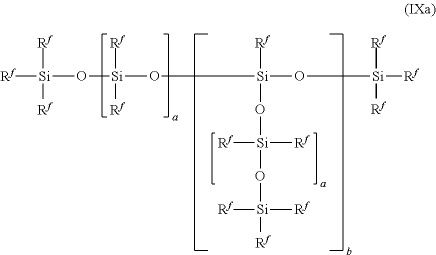

where
b is a number from 0 to 10, preferably <5 and preferably 0,
a is a number from 1 to 500, preferably 1 to 250 and preferably 1 to 100,
R^{f} is identical or different radicals R^{m} or Rⁿ, with the proviso that at least one radical R^{f} is a radical Rⁿ,
R^{m} is alkyl radicals having 1 to 18 carbon atoms, preferably 1 to 6 carbon atoms, or an aryl radical, preferably phenyl, where the radicals R^{m} may be substituted or unsubstituted,
Rⁿ is a radical of the general formula (X)

—(O)ₓ-L′-Y (X)
x=zero or one, preferably zero
L′ is a divalent, optionally branched, substituted or unsubstituted hydrocarbon radical having 1 to 60 carbon atoms, preferably 1 to 20 carbon atoms and particularly preferably 3 to 10 carbon atoms, and
Y is selected from the group comprising —OH, —SH,

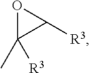

—NH₂ and —NHR³, where R³, independently of the others, is a monovalent substituted or unsubstituted, linear or branched radical containing 1 to 18 carbon atoms.

The divalent radical L′ may be interrupted by divalent radicals which are bonded to carbon atoms on both sides, such as, for example, —O—, —C(O)O—, CONR⁴, NR⁴C(O), or —C(O)—, where R⁴ is a monovalent substituted or unsubstituted, linear or branched radical containing 1 to 18 carbon atoms.

As suitable vinylic unsaturated compound V, preference is given to using a compound which comprises at least one group C(O)X′, in which X′ is a leaving group, which can be substituted in a nucleophilic attack by the O, N or S atom of the functional group of the polysiloxane and which contains at least one vinylic double bond onto which a nitroxide-terminated polymer of the formula (XV) can be added in a radical addition.

As suitable vinylic unsaturated compounds V, preference is given to using compounds of the formula (XVIII):

CH₂═CH—C(O)X′ (XVIII)

where X′ is the leaving group. Preferably, the leaving group is a halogen atom (F, Cl, Br or I) or an OH group. Very particularly preferably, X′ is an OH group.

Particularly preferably, acrylic acid is used as suitable vinylic unsaturated compound for the preparation of at least monounsaturated polysiloxanes of the formula A[L-G-C(O)—CH═CH₂]ₘ.

The nucleophilic substitution reaction between functional polysiloxane and suitable vinylic unsaturated compound can take place under the reaction conditions typical for such reactions, which are known to the person skilled in the art.

The reaction of the at least monounsaturated polysiloxane of the formula A[L-G-C(O)—CH═CH₂]ₘ with the nitroxide-terminated polymer can take place here without solvent or in the presence of a solvent or of a mixture of two or more solvents.

The solvent is preferably selected from the group comprising water, alcohols, such as e.g. ethanol, n-propanol, isopropanol, n-butanol, 2-butanol, tert-butanol, pentanol, hexanol, heptanol, octanol, cyclohexanol, aromatic solvents, chlorinated and/or fluorinated solvents, ethers, such as e.g. tetrahydrofuran, 1,4-dioxane, organic esters, such as e.g. butyl acetate, ethyl acetate, propyl acetate; ketones, preferably ethyl methyl ketone, acetone; ethers; aliphatics, preferably pentane, hexane and further polar aprotic solvents. Here, the list is only exemplary and not exhaustive.

The reaction according to step B) can be carried out at atmospheric pressure, subatmospheric pressure or superatmospheric pressure, preferably at atmospheric pressure.

The reaction according to step B) can be carried out in a temperature range from 0° C. to 90° C., preferably from 0° C. to 80° C., particularly preferably from 25° C. to less than 80° C.

The molar ratio of nitroxide-terminated polymer (XV) and unsaturated polysiloxane of the formula A[L-G-C(O)—CH═CH₂]ₘ is preferably from 1 to 1.5 m, preferably from m to 1.25 m.

The reaction according to step B) is preferably carried out under a protective gas selected from the group comprising nitrogen, noble gases, CO₂ or gaseous hydrocarbons, such as e.g. methane, or mixtures thereof. Particular preference is given to the procedure under nitrogen as protective gas.

The polyorganosiloxane compounds according to the invention of the formula (VIII) can be used diversely. In particular, the polyorganosiloxane compounds according to the invention of the formula (VIII) can be used for the preparation of cosmetic or pharmaceutical compositions or of body care compositions.

Compositions according to the invention comprise at least one polyorganosiloxane compound according to the invention of the formula (VIII) and at least one component different from this compound, e.g. a carrier suitable for cosmetic or pharmaceutical compositions or body care compositions. The compositions according to the invention can be e.g. cosmetic or pharmaceutical compositions or body care compositions.

Preferably, the compositions according to the invention comprise from 0.01 mass percent to 20 mass percent, preferably 0.05 mass percent to 10 mass percent, particularly preferably 0.1 mass percent to 3 mass percent, of at least one organopolysiloxane compound of the invention according to formula (VIII), based on the total mass of the formulation.

The compositions according to the invention can be used e.g. for the treatment of hair, as conditioners for hair treatment compositions, as hair aftertreatment compositions and for improving the hair structure. In particular, the compositions according to the invention can be used for the treatment of hair, in particular for use as hair conditioners. The organopolysiloxane compounds according to the invention can, however, also be used in a wide ranges of different product types, such as e.g. hair spray compositions, hair styling compositions, mousse, gels, lotions, sprays, shampoos, rinses, hand and body lotions, facial moisturizers, suncream, anti-acne formulations, antiaging formulations, topical analgesics, mascara and the like, the list being exemplary and nonexhaustive. The carrier substances and additional components which are required to formulate such products vary with the product type and can be selected easily by the person skilled in the art. Some possible carrier substances and additional components which may be present in compositions according to the invention are described below.

### Carrier Substances:

The compositions according to the invention can comprise e.g. a carrier or a mixture of different carriers which are suitable for use in cosmetic or pharmaceutical compositions or in body care compositions, in particular for use on hair. The content of carrier in the formulation is from 0.5% by weight to 99.5% by weight, preferably from 5.0% by weight to 99.5% by weight, particularly preferably from 10.0% to weight to 98% by weight.

The expression “suitable for use on hair” means that the carrier does not damage the hair, does not adversely affect the esthetic appearance of the hair or does not produce any irritations on the underlying skin. Suitable carriers for the use of hair care compositions in the present invention include e.g. those which are used in hair sprays, mousse, tonics, gels, shampoos, conditioners or rinses. The choice of suitable carrier depends on the block copolymer used and whether the formulated product is to remain on the surface to which it has been applied (e.g. hair spray, mousse, tonic or gel) or whether it is rinsed off again following application (e.g. shampoo, conditioner, rinses).

The carriers used can include a wide range of compounds customarily used in compositions, especially in compositions for hair care. The carriers can comprise a solvent in order to dissolve or disperse the copolymer used, preference being given to water, C₁-C₆ alcohols, alkyl acetates with alkyl radicals which comprise 1 to 10 carbon atoms, and mixtures thereof. The carriers can comprise a wide range of additional substances, such as acetone, hydrocarbons (e.g.: isobutane, pentane, hexane, decane), halogenated hydrocarbons (such as e.g. freons) and volatile silicone derivatives, such as e.g. cyclomethicone. If the formulation is a hair care composition, such as e.g. a hair spray, tonic, gel or mousse, the preferred solvents include water, ethanol, volatile silicone derivatives and mixtures thereof. The solvents which are used in such mixtures may be miscible or immiscible with one another. Mousses and aerosol hair sprays can likewise comprise any conventional propellent in order to apply the material as foam (in the case of mousse) or as a fine, uniform spray (in the case of the aerosol hair spray). Examples of suitable propellents include materials from the group comprising trichlorofluoromethane, dichlorodifluoromethane, difluoroethane, dimethyl ether, propane, n-butane or isobutane, or mixtures thereof. A tonic or hair spray product with a low viscosity can also comprise an emulsifier. Examples of suitable emulsifiers include nonionic, cationic, anionic surfactants or mixtures thereof. If such an emulsifier is used, the composition comprises the emulsifier in a concentration of from 0.01% to 7.5%. The content of propellent can be adjusted as required, but is generally between 3% and 30% for mousse compositions and from 15% to 50% in aerosol hair sprays.

Suitable containers for spraying are well known to the person skilled in the art and include conventional nonaerosol pump sprays, i.e. “atomizers”, aerosol containers cans containing propellents, as described above, and also pump aerosol containers which used compressed air as propellent.

If the (hair care) composition according to the invention is a conditioner or a rinse, the carrier can comprise a great variety of conditioning compounds. If the hair care compositions are shampoos, the carrier can comprise surfactants, suspension auxiliaries and thickeners.

The carrier can assume various appearances, e.g. the carrier can be an emulsion, which includes e.g. oil-in-water emulsions, water-in-oil emulsions, water-in-oil-in-water and oil-in-water-in-silicone emulsions. The viscosity of the emulsions can cover a range from 100 cps to 200 000 cps. These emulsions can also be sprayed using either mechanical pump containers or pressurized aerosol containers containing the customary propellents. The carriers can also be applied in the form of mousse. Other suitable topical carriers include nonaqueous liquid solvents, such as oils, alcohols and silicones (e.g. mineral oil, ethanol, isopropanol, dimethicones, cyclomethicones and the like), water-based liquid single-phase solvents (e.g. water/alcohol solvent systems) and thickened variants of these nonaqueous and water-based liquid single-phase solvents (e.g. where the viscosity of the solvent has been increased by a solid or a semisolid substance as a result of adding suitable gum, waxes, resins, polymers, salts and similar substances).

### Additional Components:

A great variety of additional components can be used in the compositions according to the invention, especially in the inventive cosmetic and body care compositions of the present invention. A list of possible components can be found e.g. in DE 10 2008 001 786. Examples include inter alia, but not exclusively:
Sunscreen agents, such as e.g. 2-ethylhexyl p-methoxycinnamate, 2-ethyl N,N-dimethyl-p-amino-benzoate, p-aminobenzoic acid, 2-phenylbenzimidazole-5-sulfonic acid, octocrylene, oxybenzone, homomethyl salicylate, octyl salicylate, 4,4′-methoxy-t-butyl-dibenzoylmethane, 4-isopropyldibenzoylmethane, 3-benzylidenecamphor, 3-(4-methylbenzylidene)camphor, titanium dioxide, zinc oxide, silica, iron oxide and mixtures thereof.
Antidandruff active ingredients such as bis(2-pyridylthio)zinc 1,1′-dioxide, piroctone, selenium disulphide, sulfur, coal tar and the like.
Conditioning agents for hair care compositions such as hydrocarbons, liquid silicones, and cationic materials. The hydrocarbons can be unbranched or branched and contain between 10 and 16 carbon atoms, preferably between 12 and 16 carbon atoms. Examples of suitable hydrocarbons are decane, dodecane, tetradecane, tridecane and mixtures thereof. Examples of conditioning agents containing silicones include inter alia cyclic or linear polydimethylsiloxanes, phenyl- and alkylphenylsilicones and silicone polyols. Cationic conditioning agents that can be used in the compositions include quaternary, also silicone-containing, ammonium salts or the salts of fatty acid amines.
Surfactants for hair shampoos and conditioning compositions. For a shampoo, the content of surfactants is preferably from 10% to 30% and particularly preferably from 12% to 25% of the composition. For conditioners, the preferred content of surfactants is from ca. 0.2% to 3%. The surfactants that can be used in the compositions include anionic, nonionic, zwitterionic, cationic and amphoteric surfactants.
Polymeric thickeners with carboxylic acid groups. These crosslinked or uncrosslinked polymers contain one or more derivatives of acrylic acid, of substituted acrylic acid, salts and esters of these acrylic acids and substituted acrylic acids, where, in the case of crosslinked polymers, the crosslinking agent contains two or more carbon-carbon double bonds. Examples of polymeric thickeners are those selected from the group comprising carbomers, acrylates/C₁₀-C₃₀ alkyl acrylates crossed copolymers and mixtures thereof. Compositions of the present invention can comprise from 0.025% to 1%, preferably from 0.05% to 0.75% and particularly preferably from 0.10% to 0.50%, of the polymeric thickener with carboxylic acid groups.
Emulsifiers for emulsifying the wide variety of carrier substances described in the composition in this invention. Suitable emulsifier types include polyethylene glycol 20 sorbitan monolaurate (polysorbate 20), polyethylene glcycol 5 soya sterol, steareth-20, ceteareth-20, PPG-2 methylglucose ether distearate, ceteth-10, polysorbate 80, cetyl phosphate, potassium cetyl phosphate, diethanolamine cetyl phosphate, polysorbate 60, glyceryl stearate, PEG-100 stearate and mixtures thereof. The emulsifiers can be used individually or as a mixture of two or more emulsifiers. The cosmetic or body care composition can comprise an emulsifier content of from 0.15 to 10%, preferably from 1% to 7% and particularly preferably from 1% to 5%.
Vitamins and derivatives thereof (e.g. ascorbic acid, vitamin E, tocopherol acetate, retinolic acid, retinol, retinoids and the like).
Cationic polymers (e.g. cationic guar derivatives such as e.g. guar hydroxyproplyltrimonium chloride and hydroxypropyl guar hydroxypropyltrimonium chloride, obtainable under the trade name Jaguar C from Rhone-Poulenc).
Preservatives, antioxidants, chelating agents and complexing agents, pearlizing agents, esthetic components such as perfume, fragrances, dyes, pigments, hair nutrients, and essential oils.
Additives which are obvious to the person skilled in the art, but are not further detailed here.

In the examples listed below, the present invention is described by way of example without intending to limit the invention, the scope of application of which arises from the entire description and the claims, to the embodiments specified in the examples.

The preparation of polydimethylsiloxane diacrylates is known in the prior art and to the person skilled in the art. The preparation of such compounds is described e.g. in DE 38 10 140. To prepare a polydimethylsiloxane diacrylate of the formula (XV) with e.g. n=30, the procedure is analogous to example 1 from DE 38 10 140. Here, one mol of an SiH-group-containing polydimethylsiloxane of the average formula given in example 1 of DE 38 10 140 where D=30 are used. To obtain the polydimethylsiloxane diacrylates where n=70 or 130, SiH-group-containing siloxanes are accordingly used. As a departure from example 1, however, 2 mol of 1-hexenol are reacted instead of 2 mol of allyl alcohol. The hydroxy-functional polydimethylsiloxane obtained in this way is then further reacted analogously to the description in example 1 with 2 mol of acrylic acid and worked-up as described.

### EXAMPLE 1

In a multineck flask equipped with stirrer, thermometer, reflux condenser, nitrogen inlet tube and dropping funnel, a mixture of 100 g of methyl isobutyl ketone, 80 g of butyl acrylate and 6.5 g of dimethylaminoethyl methacrylate were introduced as initial charge under N₂ atmosphere and carefully degassed with nitrogen. The mixture was heated to 50° C. and then 7.9 g of BlocBuilder® MA were quickly added and heated to 115° C. The mixture was then left to react with stirring for 4 h at 115° C. By means of ¹H-NMR analysis, a monomer conversion of >85% was ascertained.

Then 43 g of a polydimethylsiloxane diacrylate of the formula (XVII)

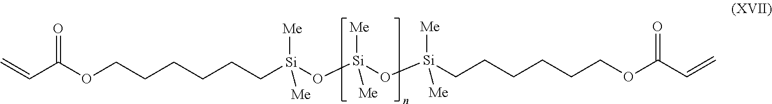

where n=30 were added and the mixture was stirred at 115° C. for a further 5 h. Then, under reduced pressure and at a temperature of <80° C., the solvent was distilled off. The residue is the desired polysiloxane-containing block copolymer.

### EXAMPLE 2

In a multineck flask equipped with stirrer, thermometer, reflux condenser, nitrogen inlet tube and dropping funnel, a mixture of 50 g of methyl isobutyl ketone, 15 g of butyl acrylate and 2.7 g of dimethylaminoethyl methacrylate were introduced as initial charge under N₂ atmosphere and carefully degassed with nitrogen. The mixture was heated to 50° C. and then 7.1 g of BlocBuilder® MA were quickly added and heated to 115° C. The mixture was then left to react with stirring for 3 h at 115° C. By means of ¹H-NMR analysis, a monomer conversion of >85% was ascertained.

Then 102 g of a polydimethylsiloxane diacrylate of the formula (XVII) where n=130 were added and the mixture was stirred at 115° C. for a further 5 h. The solvent was then distilled off under reduced pressure and at a temperature of <80° C. The residue is the desired polysiloxane-containing block copolymer.

### EXAMPLE 3

In a multineck flask equipped with stirrer, thermometer, reflux condenser, nitrogen inlet tube and dropping funnel, a mixture of 100 g of methyl isobutyl ketone, 90 g of methoxypolyethylene glycol 500 methacrylate (MPEG 500 MA, trade name of Evonik Röhm GmbH) and 1.8 g of styrene were introduced as initial charge under N₂ atmosphere and, after careful degassing, the mixture was heated to 50° C. Then 3.2 g of BlocBuilder® MA were added and the mixture was quickly heated to 80° C. and stirred at this temperature for 2 h. A carefully degassed mixture of 12.4 g of dimethylaminoethyl methacrylate and 0.9 g of styrene was then added dropwise and the mixture was heated for a further 3 h at 80° C.

Then 11.6 g of a polydimethylsiloxane diacrylate of the formula (XVII) where n=30 were added and the mixture was stirred at 80° C. for a further 10 h. The solvent was then distilled off under reduced pressure and at a temperature of <80° C. The residue is the desired polysiloxane-containing block copolymer.

### EXAMPLE 4

In a multineck flask equipped with stirrer, thermometer, reflux condenser, nitrogen inlet tube and dropping funnel, a mixture of 30 g of methyl isobutyl ketone, 95.8 g of methoxypolyethylene glycol 500 methacrylate (MPEG 500 MA, trade name of Evonik Röhm GmbH), 13.2 g of dimethylaminoethyl methacrylate and 12.0 g of styrene were introduced as initial charge under N₂ atmosphere and carefully degassed with nitrogen. The mixture was heated to 50° C. and then 1.01 g of BlocBuilder® MA was quickly added and heated to 80° C. The mixture was then left to react with stirring for 5 h at 80° C. By means of ¹H-NMR analysis, a monomer conversion of >85% was ascertained.

Then 6.2 g of a polydimethylsiloxane diacrylate of the formula (XVII) where n=30 were added and the mixture was stirred at a 80° C. for a further 9 h. The solvent was then distilled off under reduced pressure and at a temperature <80° C. The residue is the desired polysiloxane-containing block copolymer.

### EXAMPLE 5

In a multineck flask equipped with stirrer, thermometer, reflux condenser, nitrogen inlet tube and dropping funnel, a mixture of 30 g of methyl isobutyl ketone, 65 g of methoxypolyethylene glycol 500 methacrylate (MPEG 500 MA, trade name of Evonik Röhm GmbH) and 1.3 g of styrene were introduced as initial charge under N₂ atmosphere and, after careful degassing, the mixture was heated to 50° C. Then 2.6 g of BlocBuilder® MA were added and the mixture was quickly heated to 80° C. and stirred at this temperature for 2 h. A carefully degassed mixture of 8.9 g of dimethylaminoethyl methacrylate and 0.6 g of styrene was then added dropwise and the mixture was heated for a further 4 h at 80° C.

Then 38.7 g of a polydimethylsiloxane diacrylate of the formula (XVII) where n=70 were added and the mixture was stirred at 80° C. for a further 11 h. The solvent was then distilled off under reduced pressure and at a temperature <80° C. The residue is the desired polysiloxane-containing block copolymer.

### EXAMPLE 6

### Applications as Hair Conditioners

For the application-related assessment, hair tresses which are used for sensory tests are predamaged in a standardized manner by means of a permanent wave treatment and a bleaching treatment. For this, products customary in hairdressing are used. The test procedure, the base materials used and also the details of the assessment criteria are described in DE 103 27 871.

### Test Formulation:

The polysiloxane copolymers were tested in a simple hair rinse having the composition given in table 1.

TABLE 1
Composition of the test formulations

| Product | Weight fractions |
|---|---|
| TEGINACID ®C | 0.5% |
| Ceteareth-25 | |
| TEGO ®Alkanol 16 | 2.0% |
| Cetyl Alcohol | |
| (“Conditioner”) | 2.0% |
| Water | ad. 100% |
| Citric acid | ad. pH 4.0 ± 0.3 |

The products TEGINACD® C and TEGO® Alkanol 16 are available from Evonik Goldschmidt GmbH.

“Conditioners” is the term used to refer to the polyorganosiloxane compounds according to the invention described in examples 1 to 5.

Standardized treatment of predamaged hair tresses with conditioning samples:

The hair tresses predamaged as described above were treated as follows with the conditioning rinse described above:

The hair tresses were wetted under running warm water. The excess water was gently squeezed out by hand, then the rinse was applied and gently worked into the hair (1 ml/hair tress (2 g)). After a contact time of 1 min, the hair was rinsed for 1 min.

Prior to the sensory assessment, the hair was dried in the air at 50% atmospheric humidity and 25° C. for at least 12 h.

The composition of the test formulation has deliberately been chosen to be simple to avoid the influence on the test results by (normally present) formulation constituents. Besides the specified ingredients and/or instead of the specified ingredients, formulations according to the invention can also comprise further ingredients. In particular, the combination with further ingredients can lead to a synergistic improvement in the conditioning effect. Such ingredients are described above.

### Assessment Criteria

The sensory evaluations were made according to grades which were awarded on a scale from 1 to 5, with 1 being the poorest evaluation and 5 the best evaluation. The individual test criteria each receive their own evaluation. The test criteria are: detangling, wet combability, wet feel, dry combability, dry feel, shine, volume.

The results of the test of the conditioning properties of the polysiloxane block copolymers are given in table 2. The control sample contained no polysiloxane block copolymer according to the invention.

In the sensory test, the polysiloxane block copolymers have hair conditioning properties. They are significantly better than the comparison value of the control without conditioner.

TABLE 2
Conditioning properties of the polysiloxane block copolymers

| | De- | | | | | | |
|---|---|---|---|---|---|---|---|
| | tan- | Wet | Wet | Dry | Dry | | Vol- |
| Cond. | gling | combability | feel | combability | feel | Shine | ume |
| 1 | 3.0 | 3.25 | 3.2 | 3.0 | 3.0 | 3.75 | 3.75 |
| 2 | 4.0 | 4.25 | 3.5 | 3.5 | 3.0 | 3.75 | 3.0 |
| 3 | 5.0 | 4.25 | 4.25 | 4.0 | 4.5 | 4.0 | 3.5 |
| 4 | 4.75 | 4.25 | 4.25 | 3.5 | 3.5 | 3.5 | 3.0 |
| 5 | 4.5 | 4.0 | 3.75 | 4.5 | 4.5 | 4.0 | 3.0 |
| K | 1.5 | 2.0 | 1.5 | 2.0 | 2.25 | 3.0 | 2.0 |

Cond. = Conditioner according to example
K = Control (Placebo)

### EXAMPLE 7

### Formulation as Hair Spray

The polysiloxane block copolymer from example 1 was incorporated into a formulation for a nonaerosol hair spray with 80 mass % fraction of volatile organic compounds (so-called 80% VOC nonaerosol hair spray) according to the composition listed in table 3.

TABLE 3
Formulation of an 80% VOC nonaerosol hair spray

| | Fraction in % by |
|---|---|
| Component | weight |
| RESYN 28-2930 Polymer | 5 |
| AMP-95 | 0.49 |
| Polysiloxane block copolymer | 4.5 |
| from example 1 | |
| ABIL B 8843 | 0.2 |
| Deionized water | 13.81 |
| SD Alcohol 40 | 80 |

RESYN 28-293 polymer: (INCI name: VA/Crotonates/Vinyl Neodecanoate Copolymer) is a product from National Starch.
AMP-95: (INCI name: Aminomethyl Propanol) is a product from ANGUS Chemical Company.
ABIL B 8843: (INCI name: PEG-14 Dimethicone) is a product of Goldschmidt GmbH.
SD Alcohol 40: Ethanol.

The formulation from table 3 exhibited, following application as hair spray, an improved flexibility of the treated hair and produced a feel that was perceptibly better than that of a formulation which comprises no polysiloxane block copolymer according to the invention.

### EXAMPLE 8

### Formulation as Hair Styling Gel

The polysiloxane block copolymer from example 1 was incorporated into a formulation for a hair styling gel according to the composition listed in table 4.

TABLE 4
Formulation of a hair styling gel:

| | Fraction in % by |
|---|---|
| Component | weight |
| AMP-95 | 0.8 |
| Polysiloxane block copolymer | 2 |
| from example 1 | |
| Deionized water | 86.4 |
| SD Alcohol 40 | 10 |
| Carbopol ETD 2020 | 0.8 |

AMP-95: (INCI name: Aminomethyl Propanol) is a product from Angus.
Carbopol ETD 2020: (INCI name: Acrylates/C10-30 Alkyl Acrylate Crosspolymer) is a product from Noveon.

The formulation from table 4 forms a gel with a blancmange-type consistency which, when applied as styling gel, leads to adequate stability in the hair coupled with simultaneous flexibility and pleasant feel.

1. Polyorganosiloxane compound of the formula (VIII): 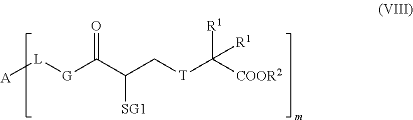
where
A is an m-valent polyorganosiloxane radical,
L is a divalent organic radical,
G=—O—, —S—, —CR³(OH)—CH(R³)—O—, —NR³—, where R³, independently of the others, is hydrogen or a monovalent substituted or unsubstituted, linear or branched organic radical containing 1 to 18 carbon atoms,
R¹ is identical or different and is a linear or branched alkyl radical having 1 to 3 carbon atoms,
R² is a hydrogen atom or a linear or branched alkyl radical having 1 to 8 carbon atoms, a phenyl radical, an alkali metal cation such as Li⁺, Na⁺ or K⁺ or an ammonium such as NH₄⁺, NR⁵R⁶R⁷R⁸⁺ where R⁵, R⁶, R⁷ and R⁸, independently of one another, are H or C₁-C₄₀ alkyl radical,
SG1 is a radical of the formula (II), 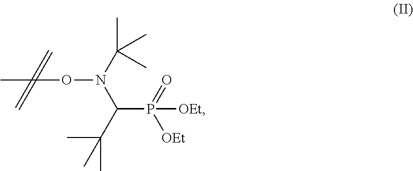
T is a polymer block composed of radically polymerized monomers, and
m is an integer from 1 to 50.

2. Polyorganosiloxane compound according to claim 1, wherein R¹=methyl and/or R²=hydrogen and/or G=oxygen.

3. Polyorganosiloxane compound according to claim 1, wherein R¹=methyl and R²=hydrogen and G=oxygen.

4. Polyorganosiloxane compound according to claim 1, wherein L is a radical —(O)ₓ-L′-, where L′ is bonded to G and is an unbranched or branched, substituted or unsubstituted organic radical haying 1 to 60 carbon atoms and x=0 or 1.

5. Polyorganosiloxane compound according to claim 4, wherein L is a linear unbranched hydrocarbon radical having 3 to 10 carbon atoms.

6. Polyorganosiloxane compound according to claim 1, wherein the unit A is a polysiloxane radical of the formula (IX) 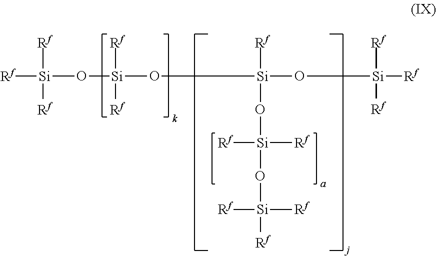
where
j is a number from 0 to 10,
k is a number from 1 to 500,
R^{f} is identical or different radicals R^{g} or a bond to the building block L with the proviso that m radicals R^{f} are a bond to the building block L,
R^{g} is substituted or unsubstituted alkyl radicals having 1 to 18 carbon atoms.

7. Polyorganosiloxane compound according to claim 1, wherein T is a polymer block composed of radically polymerized monomers, selected from substituted or unsubstituted (meth)acrylic acids and derivatives thereof and optionally unsaturated hydrocarbons.

8. A process for preparing the polyorganosiloxane compound according to claim 1 comprising
A) reacting at least one radically polymerizable monomer M with at least one alkoxyamine of the formula (VI) 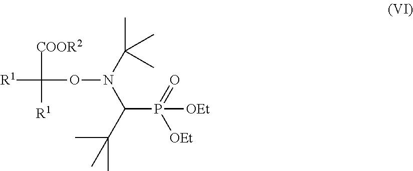
to give a nitroxide-terminated polymer (XV) 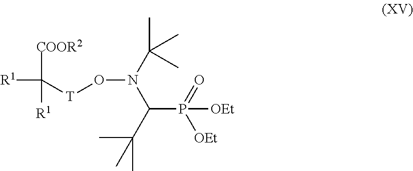
and
B) reacting the polymer (XV) with an at least monounsaturated compound of the formula (XVI)
A[L-G-C(O)—CH═CH₂]ₘ (XVI)
where R¹, R², A, L, G, T and m are as defined in claim 1.

9. The process according to claim 8, wherein the monomers M used are those of the formula (XII)
H(R⁹C═C(R¹⁰)(C(O)G′) (XII)
where radicals R⁹ and R¹⁰, independently of one another, are selected from the group comprising hydrogen, unbranched or branched C₁- to C₁₀-alkyl radicals, methoxy, ethoxy, 2-hydroxyethoxy, 2-methoxyethyl and 2-ethoxyethyl radicals and the radical G′ is selected from the group comprising -hydroxy, —O(M)_{1/v}, —OR¹¹, —NH₂, —NHR¹¹ and —N(R¹¹)(R¹²), where M is a counterion of valency v, selected from the group of the metal ions comprising alkali metal ions, alkaline earth metal ions, ammonium ions, substituted ammonium ions, such as mono-, di-, tri- or tetraalkylammonium ions, and each radical R¹¹ and R¹² can be independently selected from the group comprising hydrogen, straight-chain or branched C₁- to C₄₀-alkyl radicals, polyether radicals, polyether amine radicals, in each case optionally substituted with one or more substituents selected from the group comprising hydroxy, C₁- to C₃-alkoxy, C₁- to C₃-alkylamino and di(C₁- to C₃-alkyl)amino.

10. The process according to claim 8, wherein step A) is carried out at a temperature of greater than or equal to 80° C.

11. The process according to claim 8, wherein step B) is carried out at a temperature of from 25° C. to less than 80° C.

12. (canceled)

13. A cosmetic or pharmaceutical composition or body care composition comprising the compound of claim 1.

14. (canceled)

15. The polyorganic siloxane compound according to claim 7, wherein T is a polymer block composed of styrenes.
